(19) United States
(12) Patent Application Publication
(10) Pub. No.: US 2012/0003462 A1
(43) Pub. Date: Jan. 5, 2012

(54) NAIL-PLATED COMPOSITE STRUCTURAL SYSTEM

(76) Inventor: Chiang Heng Wong, Selangor (MY)

(21) Appl. No.: 13/131,923

(22) PCT Filed: Mar. 20, 2009
(86) PCT No.: PCT/MY09/00039

§ 371 Date: May 31, 2011

(30) Foreign Application Priority Data
Dec. 19, 2008 (MY) PI2008-5158

(51) Int. Cl. B32B 3/26; B32B 27/38; B32B 9/04; B32B 15/04; B32B 7/08; B32B 37/18

(52) U.S. Cl. 428/304.4; 156/92; 264/261; 428/411.1; 428/457; 428/413

(57) ABSTRACT

A composite structural system comprising first and second outer plates and an inner core of elastomer wherein the outer plates are formed with a plurality of nails pre-punched from the plates to provide coherent integration between the outer plates and the inner elastomer core and are fabricated either by a Post-Sandwich method or a Pre-Sandwich method

### FIELD OF THE INVENTION

This invention relates to a composite structural system for construction industry, in particular it relates to composite structural member comprising outer metal plates sandwiching an inner elastomer core.

### BACKGROUND OF THE INVENTION

Over the years, the use of composite structural system has become more apparent in the construction industry as opposed to conventional systems by using reinforced concrete, steel, timber or bricks. The advantage of the composite system over the use of conventional methods lies in its high strength/weight ratio. The basis of a composite structural system typically comprises a member with outer metal plates sandwiching an inner elastomer core.

There are several methods in existence in the making of the composite structural component in the construction industry, as illustrated in the following prior art documents:—

US Pat. No. 6,050,2008 published on Apr. 18, 2000 which discloses a composite structural laminate comprising two outer metal layers and an intermediate elastomer core, with the elastomer having a modulus of elasticity exceeding 250 MPs and tensile and compressive strengths of not less than 20 MPs and the strength of the bond between metal and elastomer to be at least 3 MPs, and

U.S. Pat. No. 2003/0104241 A1 published on 5 Jun. 2003 which generally relate to laminates comprising metal and compact or cellular polyurethane resins, to processes for the production of these laminates, and to the production of molded articles comprising these laminates, and

WO 2008/087402 A1 published on 24 Jul. 2008 which describes a structural sandwich member comprises of outer metal plates sandwiching and bonded to a core, which comprises an inner core of corrugated metal plate and a filler material of plastics or polymer, and

WO 2007/020615 A1 published on 20 Feb. 2007 on a flooring system of sandwich-like floor elements having a core of insulating material between the first and second sheets, and more especially in

GB 2414213 A-23 published on 23 Nov. 2005 which teaches a structural sandwich plate member comprising first and second outer metal plates and a core of plastics or polymer material is provided with at least one mechanical connector which may be in the form of a stud. The stud may be a stud welded to the outer plate before formation of the core or the stud may be installed after formation of the core by drilling a hole in one of the outer plate and friction welding the stud to one or both outer plates, thereby resulting that connection between the core and outer plates is vastly improved.

These prior art systems and devices all attempt to overcome the inherent problem of integrating the outer metal plates with the inner elastomer core, so as to form a coherent composite member. The integration method may be achieved simply by its natural metal-elastomer bond, by the use of special adhesives or the use of mechanical connectors. However, each of these approaches have certain-setbacks.

In the former two methods there exists problems of creep and loss of bonding of the contact surfaces with time. There has yet to be found an ideal and economical adhesive material for this purpose. In the latter method, as in the case of Patent No. GB 2414213 A-23, for instance, where mechanical connectors are used, the outer opposing metal plates and the inner core are integrated by means of metal fins, cones or studs connecting these outer metal plates. This method has a much better advantage over the former two as described earlier due to its good metal-metal framework making it a strong and coherent structure. This method however is not truly composite in the sense that the member can support loads even without the presence of the inner elastomer core. The pitfall of this method, however, lies in its fabrication process, whereby the welding procedure for the metal connectors to the metal plates can be somewhat difficult and laborious. This becomes even more apparent when the composite member is thin especially if it is in the region of 150 mm or less. The system of fins or plurality of studs used pose further difficulty to the injection process of filling the inner core with an elastomer material. Last, but not least, in this method, as there is metal to metal contact between the opposing first outer plate and second outer plate, this gives way to heat transmission from one face of the composite member through to the other. As a result, the use of elastomer such as polyurethane foam which has good heat insulation property is not effectively utilized here.

There is therefore a need for a new composite system that provides a more economical, practical and effective integration method between the outer metal plates and inner elastomer core and by doing so shall also overcome the aforesaid inherent problems.

### SUMMARY OF THE INVENTION

The present invention seeks to provide a more economical, practical and effective solution in overcoming the inherent problems of achieving a coherent integration between the outer metal plates and inner elastomer core as encountered in the existing composite systems with reference in particular to the mechanical connector system. The present invention distinguishes itself from the rest in that it comprises first and second outer plates preferably of steel, formed with a plurality of nails pre-punched from these plates, and an inner core of elastomer preferably made from polyurethane or polyisocyanurate foam material. The plurality of nails pre-punched from the first and second outer metal plates or so called “nail-plates”, provide the solution to achieving coherent integration between the outer metal nail-plates and inner elastomer core of a composite member by way of “gripping” action as well as providing an increase in surface area of contact between the outer metal nail-plates and the inner elastomer core.

The present invention lends itself suitable to be a modular system whereby individual members can be easily jointed together to form a sizeable and functional structural entity. The joints may be epoxy glued, welded or fastened using a splice plate and an array of self tapping screws.

The present invention may be fabricated by any one of the two preferred methods. One such method is called the Post-Sandwich method whereby a composite member is made with the outer metal nail-plates pressed onto the middle elastomer core by using a hydraulic press. The other method called the Pre-Sandwich method, the composite member is made with the outer metal nail-plates placed on a work bench with elastomer spacers inserted to form a void between the two metal nail-plates and the empty inner core then injected with an elastomer.

The present invention inherently facilitates strength upgrading of its member by simple addition of metal plates on to the outer metal nail-plates which may be flat or profiled. Fixing of the additional metal plate to the metal nail-plate may be done by using an adhesive coating such as epoxy or any bonding agent suitable for its purpose Alternatively, fixing of the additional metal plate to the nail-plate may be done by applying an array of welds through perforations on the additional plate. The same can also be done by using an array of self tapping screws.

The present invention may have various embodiments. Other than being used as a slab or wall panel, it may be also be caged and be used as a beam or column. The present invention exhibits flexibility in form and function.

The present invention may be made fire resistant by using fire retardant materials for the inner core and frame. The exposed metal nail-plates can be coated with a layer of fire resistant paint or any other suitable coating for its purpose.

The present invention may also be applied to it finishes. When used as a slab, the top finishing layer such as cement screed or timber flooring can be added over it. When use as a beam or a wall panel, the surfaces may be applied on to it, with a skim coat or plaster.

### BRIEF DESCRIPTION OF THE DRAWINGS

A present invention is better understood by the illustrations given in the drawings, which are not necessary drawn to scale:—

FIG. 1 is a typical member showing the fundamental concept of the composite system of the present invention.

FIG. 2 illustrates jointing by tongue and groove with epoxy as practiced in the present invention.

FIG. 3 illustrates jointing with array of welds as practiced in the present invention.

FIG. 4 illustrates splice plate jointing with array of self-tapping screws as practiced in the present invention.

FIG. 5 illustrates the Post-Sandwich fabrication process of the present invention.

FIG. 6 illustrates the Pre-Sandwich fabrication process of the present invention.

FIG. 7 illustrates the strength upgrade with plates using epoxy as in the present invention.

FIG. 8 illustrates the strength upgrade with plates using array of welds as in the present invention.

FIG. 9 illustrates the strength upgrade with plates using array of self tapping screws as in the present invention.

FIG. 10 illustrates the versatility of the present invention in various embodiments.

### DETAIL DESCRIPTION OF THE PREFERRED EMBODIMENTS

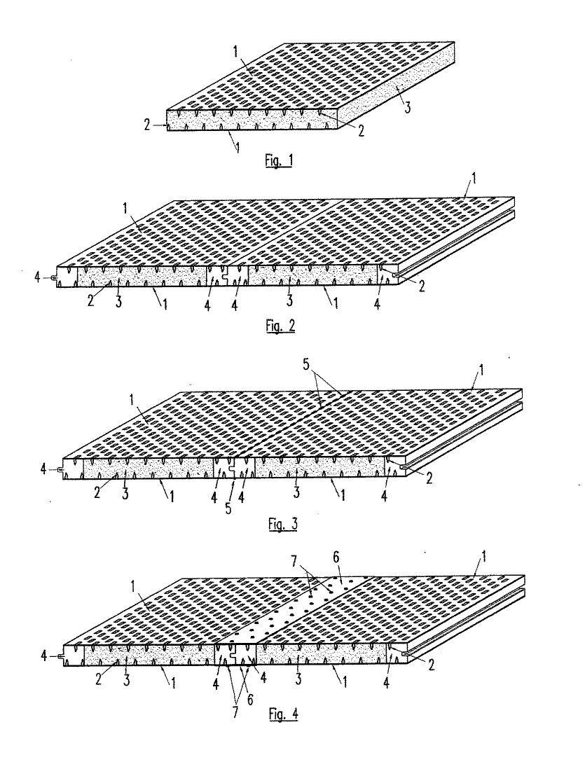

FIG. 1 is used to illustrate the fundamental concept of the present invention. It consists of first and second outer plates (1), preferably of steel, formed with a plurality of nails (2) pre-punched from these plates (1), and an inner elastomer core (3) as filler preferably made from polyurethane or polyisocyanurate foam material. The first and second outer metal plates (1) here shall be termed “nail-plates”(1) to facilitate easy description of the present invention. The plurality of nails (2) pre-punched from the first and second outer metal nail-plates (1) provide the solution to achieving a coherent integration between the outer metal nail-plates (1) and inner core (3) of a composite member by way of “gripping” action as well as providing an increase in surface area of contact between the outer metal nail-plates (1) and the inner elastomer core (3). The effectiveness of the “grip” is a function of the density and length of the nails (2). The denser and longer the nails (2) the more effective would be its “gripping” effect. However and optimum density is preferred as there is a loss of effective nail-plates (1) area with increase in nail (2) density. Generally the preferred nail density should be such that it does not take up more than 50% of its gross nail-plate surface area. The nails (2) also have an optimum length such that it shall be pierced to a given depth and not right though the entire member thickness, so that a middle gap of only the elastomer exist for it to act a thermal barrier. Preferably the length of nails (2) should be about a third of the inner core (3) thickness. The present invention is incomplete without provision of joints. The present invention lends itself to be a modular system whereby individual members can be jointed together to form a sizeable and functional structural entity. FIG. 2 illustrates the edges of the member comprising a perimeter frame (4) made of dense material preferably of thermo set plastic or timber or any other material suited for its purpose. The joints may be flat faced or with tongue-n-groove. The joints may be glued using epoxy. FIG. 3 shows the joints may be further strengthened by an array of welds (5) along the top and bottom edge joints. FIG. 4 shows steel splice plates (6) may also be employed to secure two adjacent members together with an array of self tapping screws (7).

There are two preferred methods in the fabrication process of the composite system of the present invention.

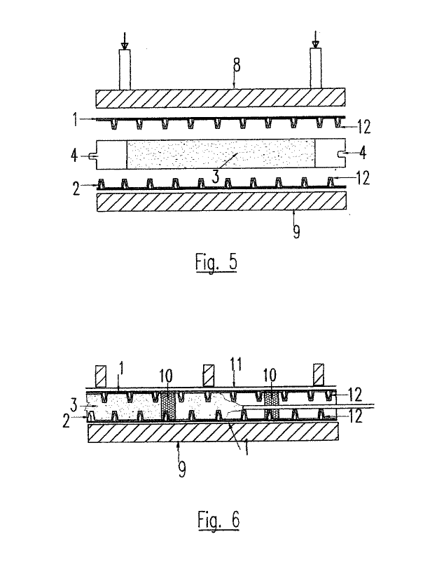

In the Post-Sandwich method as shown in FIG. 5, the composite member is made with the first and second outer nail-plates (1) pressed onto the middle core (3) by using a hydraulic press (8). The hydraulic press (8) uniformly pushes the “nails” (2) into the elastomer core (3). The nails (2) are designed to hold onto the inner core (3) by “gripping” action. This process is more suited for thicker nail-plates (1).

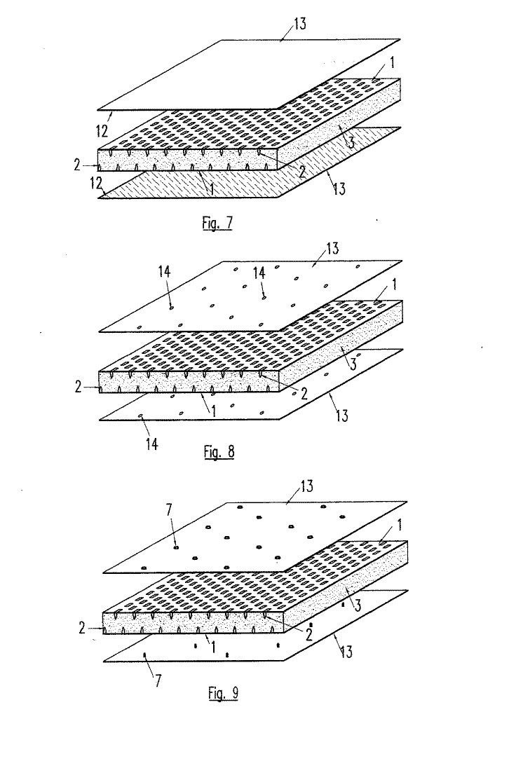

In the Pre-Sandwich method as shown in FIG. 6, the composite member is made with the first and second outer nail-plates (1) placed on a work bench (9) and elastomer spacers (10) inserted to form a void between the two metal nail-plates (1). The empty inner core (3) is then injected with an elastomer preferably PU foam. Since the nail plates (1) are perforated arising from the punched nails (2), the surface of metal nail-plate (1) may be adhered on to a thin plastic sheath (11) to prevent the PU foam from escaping through these perforations. This process is more suited for thinner nail-plates (1).

In both the above two processes, to further improve the bond between the outer metal nail-plates (1) and the inner core (3), the contact surfaces of the metal nail-plates (1) my be pre-coated with a suitable adhesive or bonding agent (12) applied prior to the fabrication process as shown in both FIG. 5 and FIG. 6.

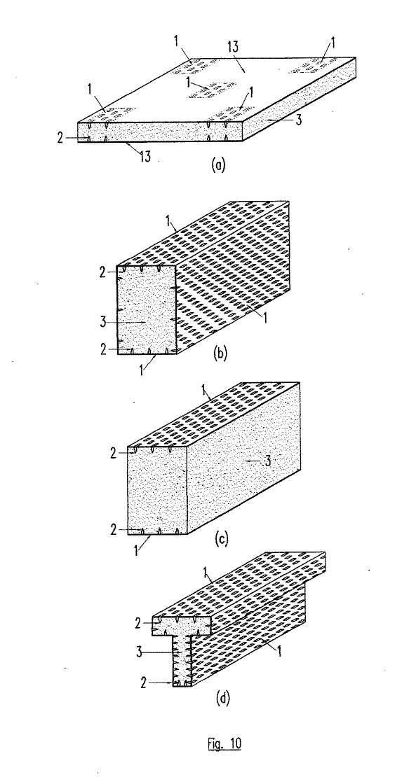

The present invention inherently facilitates strength upgrading of its member by simple addition of metal plates (13) on to the outer metal nail-plates (1) which may be flat or profiled as shown in FIGS. 7, 8 and 9. Fixing of the additional metal plate (13) to the metal nail-plate (1) may be done by using an adhesive coating (12) such as epoxy or any bonding agent suitable for its purpose as shown in FIG. 7. Alternatively, fixing of the additional metal plate (13) to the nail-plate (1) may be done by an applying an array of welds (5) through perforations (14) on the additional plate (13) as shown in FIG. 8. A neater approach to the welding method is by performing an array of spot welds to the nail-plate (1) and the additional plate (13) prior to the fabrication process. In this way the additional metal plates (13) need not be perforated and would have a smooth outer finished surface as illustrated in FIG. 7. FIG. 9 illustrates the same that can also be done using an array of self tapping screws (7).

FIG. 10 illustrates that the present invention can have various embodiments. Other than being used as a slab or wall panel, it may be also be caged and be used as a beam or column.

The finished product of the present invention may be made fire resistant by using fire retardant materials in the inner core (3), the frame (4) and the adhesive (12). The exposed steel plates (1) (13) can be coated with a layer of fire resistant paint, or any other suitable coating for its purpose.

Finishes can also be applied to the finished product of the present invention. When used as a slab, the top finishing layer such as cement screed or timber flooring can be added over it. When use as a beam or a wall panel, the surfaces may be applied on to it, with a skim coat or plaster.

The foregoing presentation of the described embodiments is provided to enable any person skilled in the art to make and use the present invention. Various modifications to these embodiments are possible, and may be applied to other embodiments as well.

As such, the present invention is not intended to be limited to the embodiments shown above, and/or any particular configuration of structure but rather is to be accorded the widest scope consistent with the principles and novel features disclosed in any fashion herein.

1. A composite structural system comprising first and second outer nail-plates and an inner core of elastomer, said nail-plates being formed with a plurality of nails pre-punched from the outer nail-plates to provide coherent integration between the outer nail-plates and the inner elastomer core.

2. The composite structural system as claimed in claim 1, wherein the outer nail-plates are made of steel or aluminum.

3. The composite structural system as claimed in claim 1, wherein the outer nail-plates form an enclosed cage framework.

4. The composite structural system as claimed in claim 1, wherein the elastomer core is made from polyurethane or polyisocyanurate material.

5. The composite structural system as claimed in claim 1, wherein the outer nail-plates are coated with a bonding agent or adhesive to improve bonding of the outer nail-plates to the inner core.

6. The composite structural system as claimed in claim 1, wherein the outer nail-plates and the inner core are both fire resistant.

7. A plurality of the composite structural systems as claimed in claim 1, wherein the jointing of adjacent ones of the composite structural systems are jointed together is by welding the first and second outer nail-plates by an array of welds or by coupling adjacent ones of the composite structural system together using splice plates and self-tapping screws.

8. The composite structural system as claimed in claim 1, wherein the composite structural system is strengthen by additional plates coupled on the outer nail-plates by means of one of an epoxy coating, by an array of welds or by self-tapping screws.

9. The composite structural system as claimed in claim 1, wherein the composite structure includes an edge which comprises a perimeter frame made of dense material of thermostat plastic or timber.

10. A process of fabricating a composite structural system comprising a first and second outer nail-plates and an inner elastomer core wherein the outer nail-plates are formed with a plurality of nails pre-punched from the outer nail-plates, said method comprising one of:
i) pressing the outer nail-plates into said elastomer core; or
ii) injection an uncured form of the elastomer core material between the outer nail-plates and allowing the elastomer core material to cure.
